(19) United States
(12) Patent Application Publication
(10) Pub. No.: US 2007/0278809 A1
(43) Pub. Date: Dec. 6, 2007

(54) Living Hinge Belt Line Vacuum Form Edge Wrap

(75) Inventors: Randy S. Reed, Fair Haven, MI (US); David J. Dooley, Troy, MI (US); Todd L. DePue, Brighton, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 11/422,081

(22) Filed: Jun. 4, 2006

(51) Int. Cl. B62D 39/00

(52) U.S. Cl. 296/1.08; 296/146.7

(57) ABSTRACT

A method of forming a trim panel is provided comprising molding an interior panel substrate including a main body portion, a lock portion molded as a portion of the interior panel substrate and having a locking element, a first living hinge positioned between the lock portion and the main body portion, a lock engagement portion, and a second living hinge positioned between the lock engagement portion and the main line portion. The method molds an exterior cover stock, including a belt line skin portion, onto an outer surface of the interior panel substrate. The lock portion is rotated about the first living hinge to trap the belt line skin portion between the lock portion and the lock engagement portion in order to create a mechanical skin lock. The lock engagement portion is then rotated about the second living hinge towards an inner surface of the interior panel substrate.

### TECHNICAL FIELD

The present invention relates generally to a method and resultant apparatus for producing trim panels with improved edge wrap and more particularly to a method and apparatus for edge wrap utilizing a mechanical skin lock.

### BACKGROUND OF THE INVENTION

Automotive trim panels commonly are constructed using semi-rigid molded interior panels coated with an outer cover material suitable for a Class-A surface. During manufacturing of these panels and assembly into the vehicle, the panel may be subject to thermodynamic and mechanical stresses that adversely effect the trim edge where the outer cover material ends. This trim edge is subject to delamination or damage during subsequent operations. Damage to the trim edge can serve to lower surface classification and may result in an unreasonable increase in damaged parts.

In addition, application of the outer cover material over panel edges presents complications to vacuum molding procedures. As such many current designs have turned to the use of extra mechanical structures to secure the outer cover. The use of complex and costly additional mechanical steps, such as post re-head and edge wrapping, in order to adequately restrain the trim edge and/or provide sufficient edge cover adds undesirably time and cost to production. Despite the additional time and added labor required to perform these existing procedures, most do not insure zero failure in the field.

It would be highly desirable to have a method and resultant trim panel that was produced with simple manufacturing steps without significant cost or labor increases that would properly secure the trim edge and provide adequate edge cover.

### SUMMARY OF THE INVENTION

In accordance with the objects of the present invention a method of forming a trim panel is provided comprising molding an interior panel substrate including a main body portion, a lock portion molded as a portion of the interior panel substrate and having a locking element, a first living hinge positioned between the lock portion and the main body portion, a lock engagement portion, and a second living hinge positioned between the lock engagement portion and the main line portion. The method molds an exterior cover stock, including a belt line skin portion, onto an outer surface of the interior panel substrate. The lock portion is rotated about the first living hinge to trap the belt line skin portion between the lock portion and the lock engagement portion in order to create a mechanical skin lock. The lock engagement portion is then rotated about the second living hinge towards an inner surface of the interior panel substrate.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of an apparatus and method of forming a vacuum formed trim panel in accordance with the present invention, the illustration showing an initial molding.

FIG. 2 an illustration of an apparatus and method of forming a vacuum formed trim panel as illustrated in FIG. 1, the illustration showing the formation of a mechanical skin lock.

FIG. 3 an illustration of an apparatus and method of forming a vacuum formed trim panel as illustrated in FIG. 1, the illustration showing the formation of a cover stock hard corner.

### DESCRIPTION OF PREFERRED EMBODIMENTS

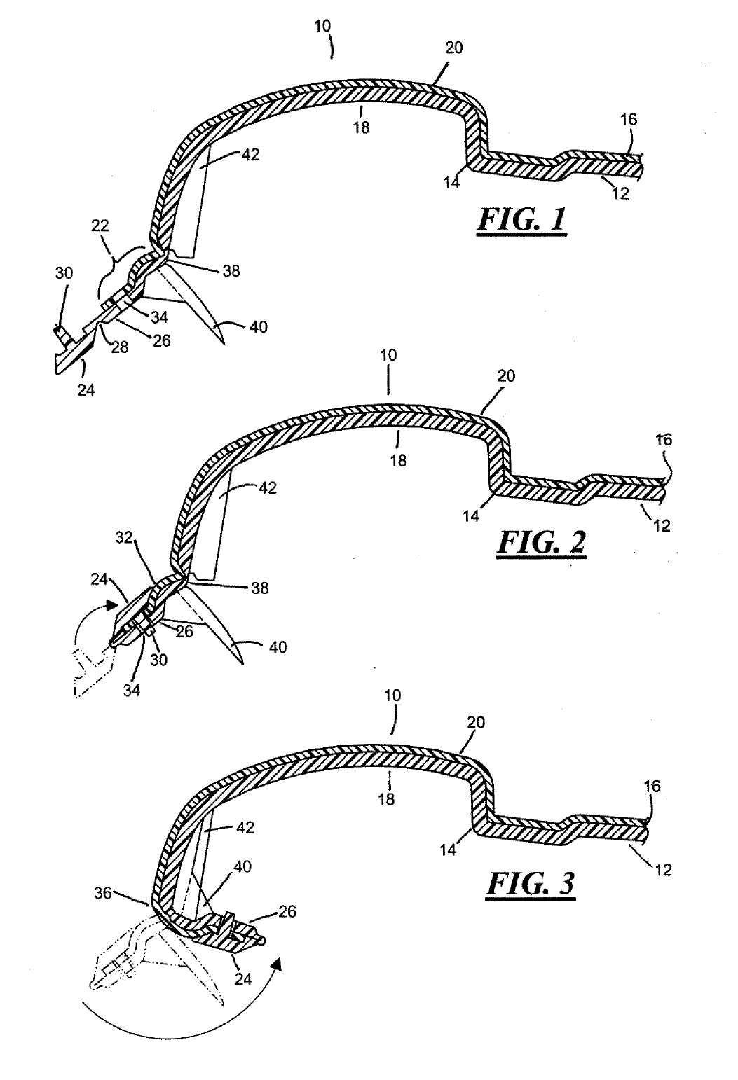

Referring now to FIG. 1, which is an illustration of method for forming and resultant vacuum formed trim panel 10 in accordance with the present invention. Although the present invention is contemplated for use in automotive interior trim panels, it is understood that the developed technology disclosed herein may be applicable to a wide variety of trim panel applications.

The vacuum formed trim panel 10 includes an internal panel substrate 12 preferably molded as a rigid plastic substrate. The internal panel substrate 12 includes an inner surface 14 and an outer surface 16. It is comprised of at least three main portions. A main body portion 18 is formed of the desired shape of the trim panel 10. An exterior cover stock 20 is vacuum molded over the outer surface 16 to crease a class-A surface suitable for consumer exposure. The exterior cover stock 20 is preferably formed from vinyl but is contemplated to include, but not be limited to, PVC/UEV, PVC ABS, TPO, TPU, TPE. In addition it is contemplated that these materials may be either foam backed or not. Where the exterior cover stock 18 comes to an end on the outer surface 16 it forms a belt-line skin portion 22. Prior art references require considerable manufacturing effort, time and cost such as through the use of post-wrapping to ensure proper affixing of the belt-line skin portion 22.

The present invention, however, utilizes a unique design including a locking portion 24 and a locking engagement portion 26 affixed to the main body portion 18. The locking engagement portion 26 is positioned between the locking portion 24 and the main body portion 18. The locking portion 24 is affixed via a first living hinge portion 28 to the locking engagement portion 26. The locking portion 24 includes a locking element 30 configured to mate and lock with the locking engagement portion 26. The locking portion 24 is folded upwards about the first living hinge portion 28 and engages the locking engagement portion 26 and traps the belt-line skin portion 22 there-between to form a mechanical skin lock 32 (see FIG. 2). In one embodiment, the locking element 30 comprises a sonic weld pin and a sonic weld slot 34 is formed in the locking engagement portion 26 and the belt-line skin portion 22. After the sonic weld pin 30 is positioned within the sonic weld slot 34 is can be sonically welded to secure the mechanical skin lock 32. In other embodiments, however, other locking mechanisms such as snap-features or other pins may be substituted for the sonic weld pin 30.

Once the mechanical skin lock 32 is formed and the belt-line skin portion 22 is adequately secured, it is further contemplated that the locking engagement portion 26 may itself be rotated to allow for the formation of a cover stock hard corner 36 as shown in FIG. 3. This is also referred to as a cover stock belt-line edge. This is easily accomplished by the formation of a secondary living hinge portion 38 positioned between the locking engagement portion 26 and the main body portion 18. The second living hinge portion 38 preferably rotates in a direction opposition the first living hinge portion 28 such that the exterior cover stock 16 is rotated inwards towards the inner surface 14 in order to form the corner 36.

It is contemplated that at least one sonic weld tab 40 may be formed on the inner surface 14 of the locking engagement portion 26. The sonic weld tab 40 is configured to engage a stop rib 42 formed on the inner surface 14 of the main body portion 18. After the locking engagement portion 26 is rotated until the sonic weld tab 40 meets the stop rib 42, the tab and rib 40,42 may be welded together via sonic welding or other techniques to secure the final shape of the vacuum formed trim panel 10. The resultant structure provides a simple and reliable method of insuring an exterior cover stock 20 is reliably affixed to the internal panel substrate 12 including formation of stock covered edges 36 without concern for delamination.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A vacuum formed trim panel comprising:
an interior panel substrate comprising:
a main body portion;
a lock portion molded as a portion of the interior panel substrate, said lock portion including a locking element;
a first living hinge positioned between said lock portion and said main body portion; and a lock engagement portion;
an exterior cover stock molded onto an outer surface of said interior panel substrate, said exterior cover stock including a belt line skin portion;
wherein said lock portion rotates about said first living hinge to trap said belt line skin portion between said lock portion and said lock engagement portion creating a mechanical skin lock.

2. A vacuum formed trim panel as described in claim 1, further comprising:
a second living hinge positioned between said lock engagement portion and said main body portion, said lock engagement portion positioned between said lock portion and said main body portion;
wherein said lock engagement portion rotates about said second living hinge portion such that said belt line skin portion is rotated towards an inner surface of said interior panel substrate.

3. A vacuum formed trim panel as described in claim 1, wherein:
said locking element comprises a sonic weld pin;
said locking engagement portion includes a sonic weld slot; and
said sonic weld pin is inserted within said sonic weld slot and welded thereto.

4. A vacuum formed skin panel as described in claim 2, further comprising:
at least one sonic weld tab formed on said lock engagement portion; and
at least one stop rib formed on said inner surface, said sonic weld tab engaging said stop rib when said belt line skin portion is rotated towards an inner surface of said interior panel substrate.

5. A vacuum formed skin panel as described in claim 4, wherein said at least one sonic weld tab is welded to said at least one stop rib.

6. A vacuum formed skin panel as described in claim 1, wherein said exterior cover stock comprises vinyl.

7. A vacuum formed skin panel as described in claim 1, wherein said interior panel substrate comprises a rigid plastic substrate.

8. A vacuum formed skin panel as described in claim 2, wherein said first living hinge and said second living hinge are configured to rotate in opposite directions.

9. A method of forming a trim panel comprising:
molding an interior panel substrate comprising:
a main body portion;
a lock portion molded as a portion of the interior panel substrate, said lock portion including a locking element;
a first living hinge positioned between said lock portion and said main body portion; and
a lock engagement portion;
molding an exterior cover stock onto an outer surface of said interior panel substrate, said exterior cover stock including a belt line skin portion;
rotating said lock portion about said first living hinge to trap said belt line skin portion between said lock portion and said lock engagement portion to create a mechanical skin lock.

10. A method as described in claim 9, further comprising;
forming a second living hinge positioned between said lock engagement portion and said main line portion; and
rotating said lock engagement portion about said second living hinge towards an inner surface of said interior panel substrate.

11. A method as described in claim 9, further comprising:
sonic welding said locking element to said lock engagement portion.

12. A method as described in claim 10, further comprising:
rotating said lock engagement portion about said second living hinge until at least one sonic weld tab formed on said lock engagement portion engages at least one stop fib formed on said inner surface.

13. A method as described in claim 12, further comprising:
sonically welding said sonic weld tab to said stop rib.

14. A method as described in claim 10, wherein rotating said lock engagement portion forms a cover stock hard corner.

15. A method as described in claim 9, further comprising:
forming said locking element as a sonic weld pin;
forming a sonic weld slot within said locking engagement portion;
rotating said lock portion such that said sonic weld pin enters said sonic weld slot; and
sonically welding said sonic weld pin within said sonic weld slot.

16. A method of forming a trim panel comprising:
molding an interior panel substrate comprising:
a main body portion;
a lock portion molded as a portion of the interior panel substrate, said lock portion including a locking element;
a first living hinge positioned between said lock portion and said main body portion;
a lock engagement portion; and
a second living hinge positioned between said lock engagement portion and said main line portion;
molding an exterior cover stock onto an outer surface of said interior panel substrate, said exterior cover stock including a belt line skin portion;
rotating said lock portion about said first living hinge to trap said belt line skin portion between said lock portion and said lock engagement portion to create a mechanical skin lock; and
rotating said lock engagement portion about said second living hinge towards an inner surface of said interior panel substrate.

17. A method as described in claim 16, further comprising:
sonic welding said locking element to said lock engagement portion.

18. A method as described in claim 16, further comprising:
rotating said lock engagement portion about said second living hinge until at least one sonic weld tab formed on said lock engagement portion engages at least one stop rib formed on said inner surface;
welding said at least one sonic weld tab to said at least one stop rib.

19. A method as described in claim 16, wherein rotating said lock engagement portion forms a cover stock hard corner.

20. A method as described in claim 16, further comprising:
forming said locking element as a sonic weld pin;
forming a sonic weld slot within said locking engagement portion;
rotating said lock portion such that said sonic weld pin enters said sonic weld slot; and
sonically welding said sonic weld pin within said sonic weld slot.
